(19) United States
(12) Patent Application Publication
(10) Pub. No.: US 2014/0367072 A1
(43) Pub. Date: Dec. 18, 2014

(54) HEAT PIPE AND METHOD FOR MANUFACTURING THEREOF

(71) Applicant: FOXCONN TECHNOLOGY CO., LTD., New Taipei (TW)

(72) Inventors: SHIH-YAO LI, New Taipei (TW); JUI-WEN HUNG, New Taipei (TW)

(73) Assignee: FOXCONN TECHNOLOGY CO., LTD., New Taipei (TW)

(21) Appl. No.: 14/253,177

(22) Filed: Apr. 15, 2014

(30) Foreign Application Priority Data
Jun. 14, 2013 (TW) 102121089

(51) Int. Cl. F28D 15/02; B23K 1/20; B23K 31/02

(52) U.S. Cl. CPC F28D 15/02; B23K 31/02; B23K 1/20; B23K 2201/14
USPC 165/104.21; 228/248.1; 228/176

(57) ABSTRACT

Method for manufacturing a heat pipe is disclosed. A tube and a vessel mesh are provided. Solder paste in a pattern is coated on the vessel mesh. The vessel mesh is rolled into a vessel and the vessel is placed in the tube. The tube is heat to weld to the vessel to the tube. The present disclosure also provides an exemplary heat pipe having a vessel welded therein.

### FIELD

The disclosure relates generally to heat pipes and, particularly, to a heat pipe having wick structures and a method for manufacturing the heat pipe.

### BACKGROUND

With the continuing development of electronic technology, electronic components are made to have smaller sizes and higher frequencies. However, issues of heat dissipation can increase accordingly. In order to cool the electronic components, heat dissipation devices, such as heat pipes, are used to dissipate heat from the electronic components. Heat pipes have excellent heat transfer performance due to their low thermal resistance, and are therefore an effective means for transferring or dissipating heat from heat sources. Currently, heat pipes are widely used for removing heat from heat-generating components such as central processing units (CPUs) of computers.

A heat pipe is usually a vacuum tube containing a working medium therein. The working medium is employed to carry, under phase change between liquid state and vapor state, thermal energy from an evaporator section to a condenser section of the heat pipe. Preferably, a wick structure is provided inside the heat pipe, attached to an inner surface of the tube, for drawing the working medium back to the evaporator section after it is condensed at the condenser section. In operation, the evaporator section of the heat pipe is maintained in thermal contact with a heat-generating component. The working medium contained at the evaporator section absorbs heat generated by the heat-generating component and then turns into vapor and moves towards the condenser section where the vapor is condensed into condensate after releasing the heat into the ambient environment. Due to the difference in capillary pressure which develops in the wick structure between the two sections, the condensate is then brought back by the wick structure to the evaporator section where it is again available for evaporation.

The wick structure is generally formed on the inner surface of the tube by heating and bonding the wick structure and the tube under a high temperature. Atoms from the wick structure and the tube could be bonded in a covalent bond or an electrovalent bond in the bonding process.

### BRIEF DESCRIPTION OF THE DRAWINGS

The components of the drawings are not necessarily drawn to scale, the emphasis instead being placed upon clearly illustrating the principles of the embodiments of the display device. Moreover, in the drawings, like reference numerals designate corresponding parts throughout several views.

FIG. 1 is a flow chart of a method for manufacturing a heat pipe in accordance with an exemplary embodiment of the present disclosure.

FIG. 2 is an isometric view of a tube and a vessel mesh in accordance with the exemplary embodiment of the present disclosure by a first step of the method of FIG. 1.

FIG. 3 is an isometric view showing the solder paste printed on the vessel net in accordance with a first embodiment of the present disclosure by a second step of the method of FIG. 1.

FIG. 4 is an isometric view showing the solder paste printed on the vessel net in accordance with a second embodiment of the present disclosure by a second step of the method of FIG. 1.

FIG. 5 is an isometric view of rolling the vessel net to a vessel and placing the vessel in the tube in accordance with the embodiment of the present disclosure by a third step of the method of FIG. 1.

FIG. 6 is a cross section of the heat pipe manufactured by the method of FIG. 1.

### DETAILED DESCRIPTION

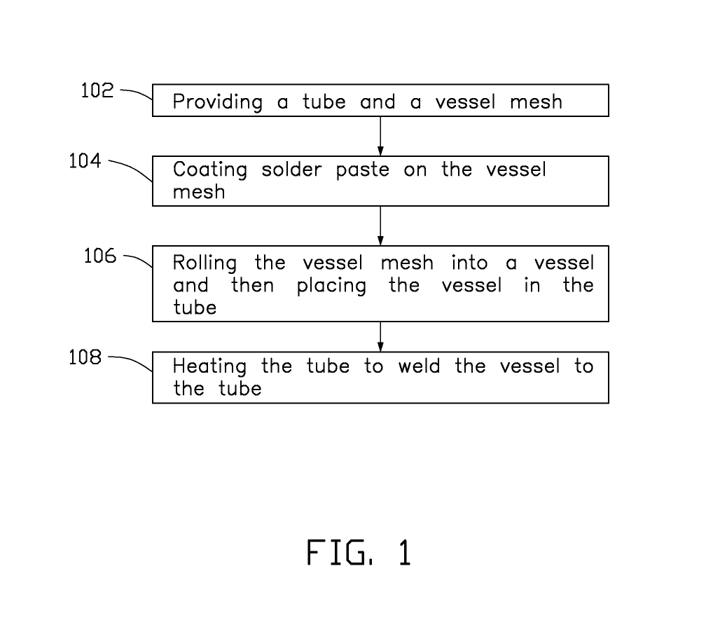

Referring to FIG. 1, a flow chart of a method of manufacturing a heat pipe in accordance with an exemplary embodiment of the present disclosure is shown. The method can include:
providing a tube and a vessel mesh (block 102);
coating solder paste on the vessel mesh (block 104); rolling the vessel mesh into a vessel and then placing the vessel in the tube (block 106); and
heating the tube to weld the vessel to the tube (block 108).

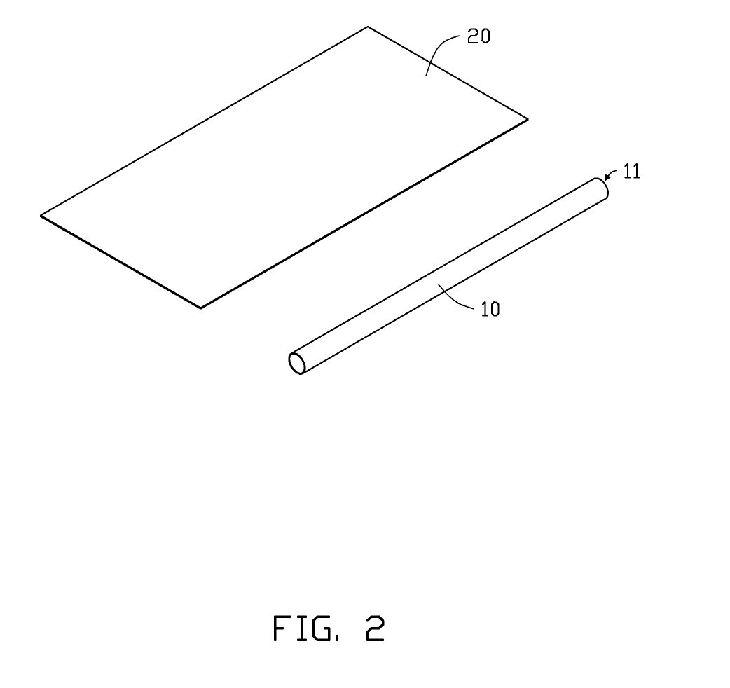

Also referring to FIG. 2, in the first step, a tube 10 and a vessel mesh 20 can be provided. The tube 10 is made of a material exhibiting excellent thermal, such as copper. The tube 10 can be a cylindrical metal casing with a hollow cavity formed therein. A cross section of the tube 10 orthogonal to the axis thereof can be circular. Two opposite ends of the tube 10 each define an opening 11. The vessel mesh 20 is weaved with brass wires which has a diameter, which for example can be 0.05 millimeter (mm) The vessel mesh 20 has a plurality of pores (not shown) defined between neighboring brass wires. The vessel mesh 20 is flexible and can be rolled into a hollow cylinder so that the vessel mesh can be inserted in the tube 10. A length of the vessel mesh 20 is larger than that of the tube 10. A width of the vessel mesh 20 can be larger than or equal to a perimeter of an inner wall of the tube 10. The tube 10 and the vessel mesh 20 could be cleaned before the following process to remove grease thereon, thereby avoiding the grease to reduce cooling efficiency of the vessel mesh 20 when the vessel mesh 20 acts as a wick structure in the heat pipe 100.

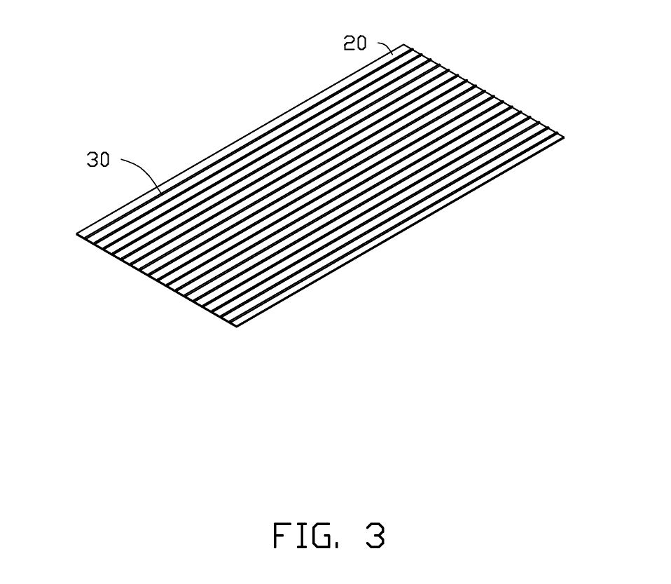

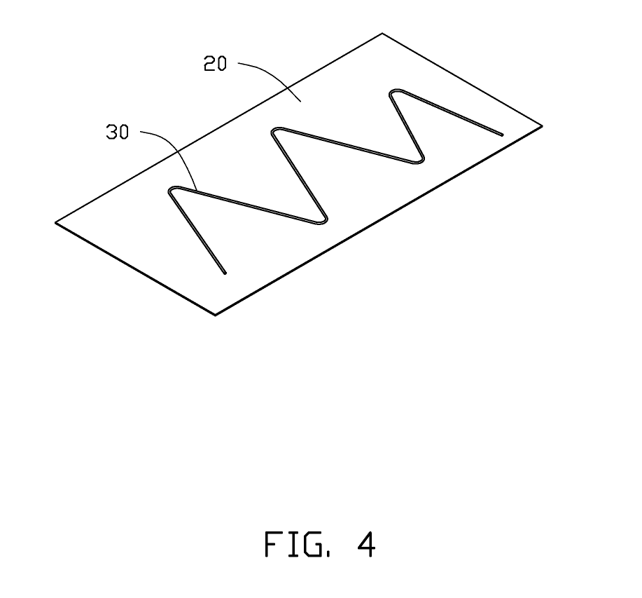

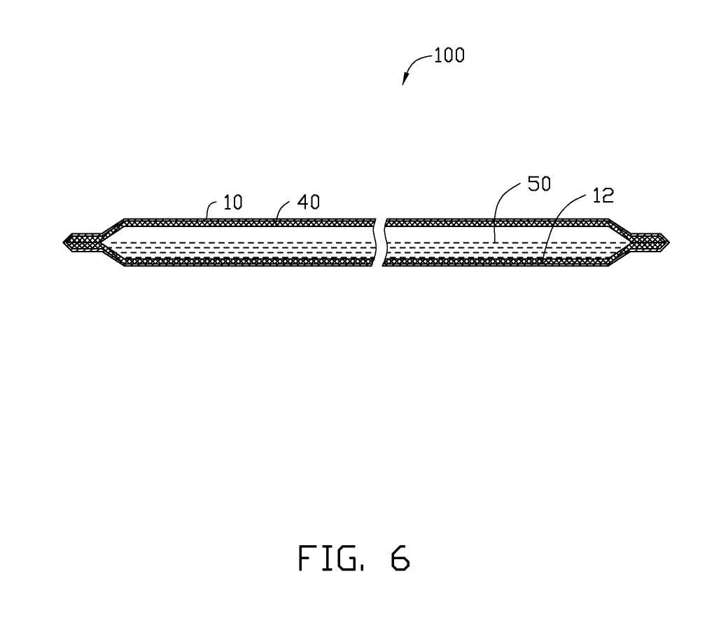

In the second step, solder paste 30 is coated on the vessel mesh 20. In the present discloser, the solder paste 30 is coated by screen printing in a pattern. The pattern of the solder paste 30 substantially matches the pattern of the screen in the screen printing process. The solder paste 30 can be printed in several parallel lines, as shown in FIG. 3. The solder paste 30 can also be printed in a continuous curve, as shown in FIG. 4. Alternatively, the solder paste 30 can be printed in other patterns according to different requirements. The solder paste 30 is coated on the vessel mesh 20 in a pattern, rather than completely covering the vessel mesh 20, thereby allowing working medium 50 (shown in FIG. 6) to penetrate pores in the vessel mesh 20 and thereby reducing thermal transfer resistance.

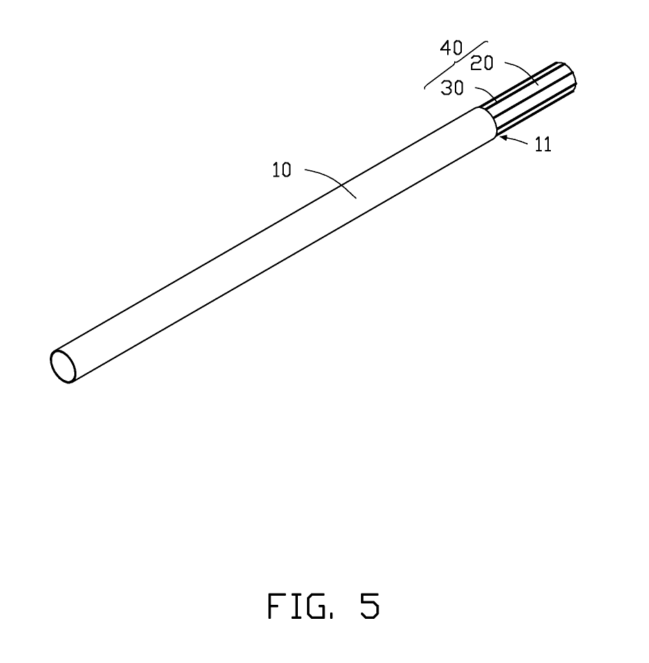

Referring to FIG. 5, in the third step, the vessel mesh 20 is rolled into a vessel 40 and then the vessel 40 is placed in the tube 10. The solder paste 30 is on an outer surface of the vessel 40 when the vessel mesh 20 is rolled into the vessel 40. The solder paste 30 is then positioned between the inner wall 12 of the tube 10 and the outer surface of the vessel 40 after the vessel 40 placed in the tube 10. Two edges of the vessel mesh 20 can abut each other in the rolling process, thereby forming the monolayer vessel 40. The solder paste 30 on the outer surface of the vessel 40 is attached to the inner wall 12 of the tube 10. The portion of the outer surface of the vessel 40 not covered by the solder paste 30 is attached to the inner wall of the tube 10 as firmly as possible, which is a benefit for enhancing a fluent flowing of the working medium 50 (shown in FIG. 6) in the vessel 40 during the operation of the heat pipe 100.

In the fourth step, the tube 10 with the vessel 40 attached therein is heated to solidify the solder paste 30 and weld to bond the vessel 40 onto the tube 10. In the heating process, the tube 10 is placed under a high temperature. At the same time, an air pumping process is also provided to remove organic matter from the solder paste 30.

In the fifth step, the working medium 50 (shown in FIG. 6) is filled in the tube 10, the tube 10 is vacuumed, and then sealed to obtain the heat pipe 100. Furthermore, the heat pipe 100 is further bended or flattened to have predetermined shapes.

The heat pipe 100 manufactured by welding which can be operated under a temperature lower than the bonding process can integrate the vessel 40 into the tube 10 firmly and reduce thermal transfer resistance. Thus, the typical manufacturing processes for coating the solder paste 30 outside the vessel 40 in patterns, such as in lines or in a curve, can provide enhanced for bonding of the vessel 40 with the tube 10 and can significantly prevent the solder paste 30 from blocking the pores in the vessel mesh 20. Accordingly, the heat pipe 100 of the present disclosure can be made more easily. Furthermore, the simplification of the manufacturing processes of the present disclosure can protect the vessel mesh 20 (wick structure) of the heat pipe 100 from being dropped from the tube 10 because of a poor contact between the vessel mesh 20 and the tube 10. Therefore, the quality and heat transferring capability of the heat pipe 100 is improved.

Referring to FIG. 6, the present disclosure also provides a heat pipe 100 manufactured by the method described above. The heat pipe 100 includes a tube 10, a vessel 40 and working medium 50. The tube 10 has an inner wall 12. The vessel 40 is attached on the inner wall 12 of the tube 10 with solder paste 30 (shown in FIGS. 3 and 4). The working medium is sealed in the tube 10.

The solder paste 30 is distributed between the tube 10 and the vessel 40 in a pattern, such as in several lines or in a continuous curve.

It is to be further understood that even though numerous characteristics and advantages have been set forth in the foregoing description of the embodiment(s), together with details of the structures and functions of the embodiment(s), the disclosure is illustrative only; and that changes may be made in detail, especially in the matters of shape, size, and arrangement of parts within the principles of the disclosure to the full extent indicated by the broad general meaning of the terms in which the appended claims are expressed.

What is claimed is:

1. A method for manufacturing a heat pipe, the heat pipe comprising a tube having an inner wall, a vessel attached on the inner wall of the tube with a patterned solder paste, and working medium sealing in the tube, the method comprising:
providing the tube and a vessel mesh;
coating solder paste on the vessel mesh in a pattern;
rolling the vessel mesh into the vessel and then placing the vessel in the tube; and
heating the tube to weld the vessel onto the tube.

2. The method of claim 1, wherein the solder paste is printed in several lines on the vessel mesh.

3. The method of claim 1, wherein the solder paste is printed in a continuous curve on the vessel mesh.

4. The method of claim 1, further comprising cleaning the vessel mesh and the tube prior to the step of coating solder paste.

5. The method of claim 1, further comprising screen printing over the solder paste in the step of coating solder paste on the vessel mesh.

6. The method of claim 1, wherein two edges of the vessel mesh abut each other to form the monolayer vessel in the step of rolling the vessel mesh into a vessel.

7. The method of claim 1, further comprising steps of filling working medium in the tube, vacuuming the tube and sealing the tube, which are performed in sequence after the step of heating the tube to weld the vessel to the tube.

8. The method of claim 1, wherein the vessel mesh is weaved with brass wires having a diameter of 0.05 millimeter.

9. The method of claim 1, further comprising attaching the solder paste on an outer surface of the vessel to the inner wall of the tube, and attaching the portion of the outer surface of the vessel not covered by the solder paste to the inner wall of the tube in the step of placing the vessel in the tube.

10. A heat pipe, comprising:
a tube having an inner wall;
a vessel attached on the inner wall of the tube with solder paste, the solder paste being distributed between the tube and the vessel in a pattern; and
working medium sealed in the tube.

11. The heat pipe of claim 10, wherein the solder paste is distributed between the tube and the vessel in several lines.

12. The heat pipe of claim 10, wherein the solder paste is distributed between the tube and the vessel in a continuous curve.

13. The heat pipe of claim 10, wherein the vessel has a monolayer structure.

14. The heat pipe of claim 13, wherein the vessel is weaved with brass wires having a diameter of 0.05 millimeter.

15. The heat pipe of claim 10, wherein the solder paste on an outer surface of the vessel is attached to the inner wall of the tube, and the portion of the outer surface of the vessel not covered by the solder paste is attached to the inner wall of the tube in the step of placing the vessel in the tube.
